(19) United States
(12) Patent Application Publication
(10) Pub. No.: US 2013/0087108 A1
(43) Pub. Date: Apr. 11, 2013

(54) COMBUSTION-ENGINED SETTING TOOL

(71) Applicant: HILTI AKTIENGESELLSCHAFT, Schaan (DE)

(72) Inventor: Hans GSCHWEND, Buchs (CH)

(73) Assignee: HILTI AKTIENGESELLSCHAFT, Schaan (DE)

(21) Appl. No.: 13/665,167

(22) Filed: Oct. 31, 2012

Related U.S. Application Data
(63) Continuation of application No. 11/725,075, filed on Mar. 15, 2007, now abandoned.

(30) Foreign Application Priority Data
Mar. 22, 2006 (DE) 10 2006 000 127.3

(51) Int. Cl. F02B 63/02

(52) U.S. Cl. 123/2

(57) ABSTRACT

A combustion-engined setting tool for driving fastening elements in a workpiece includes a combustion chamber (14) for an oxidant-fuel mixture, a ventilator (16) located in the combustion chamber and driven by an electric motor (18), and an electrical energy source (24) for supplying electrical energy to the electric motor (18) which forms part of a generator unit (30) for generating the electrical energy.

### BACKGROUND OF THE INVENTION

1. Field of the Invention

The present invention relates to a combustion-engined setting tool for driving fastening elements such as nails, bolts, pins in a constructional component and a workpiece and including a combustion chamber for an oxidant-fuel mixture, a ventilator located in the combustion chamber, an electric motor for driving the ventilator, and electrical energy source for supplying electrical energy to the electric motor.

2. Description of the Prior Art

Setting tools of the type described above can operate using gaseous or evaporated liquid fuels. In combustion-engined setting tool, during a setting process, the setting piston is driven by combustion gases. With the setting piston, fastening elements can be driven in a constructional component or workpiece.

The above-described setting tools also include electronic components such as electronically controlled valves, ignition units, ventilators, sensors, etc. These components and their control device should be supplied with power which is desirable to be network-independent.

U.S. Pat. No. 4,403,722 discloses a gas-operated setting tool in which the gas mixture of air and fuel gas that fills the combustion chamber is homogenized by an electrically driven ventilator before ignition. For supplying current for the ventilator drive and its control device, battery cells are provided.

A drawback of the setting tool of U.S. Pat. No. 4,403,722 consists in that the battery cells after being discharged, should be replaced or be recharged by supplying an external energy. To this end, the battery cells should be withdrawn from the setting tool, which is inconvenient for the tool operator.

Accordingly, an object of the present invention is to provide a setting tool of the type described above that can be operated independently on what site it is used and in which the above-discussed drawback is eliminated.

### SUMMARY OF THE INVENTION

This and other objects of the present invention, which will become apparent hereinafter, are achieved by providing a setting tool in which the electric motor part of a generator unit for generating the electrical energy, in particular of a generator unit that converts the combustion energy into the electrical energy. This features permit to generate the electrical energy from a combustion process in a simple way and without large additional expenses. The generated electrical energy can be used for recharging the electrical energy source, e.g., one or more batteries and accumulators.

It is advantageous when the generator unit has a control unit for switching the electric motor between a motor operational state and a generator operational state. In the motor operational state, the control unit controls the prime power of the electric motor and in the generator operational state, controls the generator current of the electric motor than acts as charging current for the electrical energy source. The switching from the motor operational state to the generator operational state can be initiated by, e.g., a triggering signal, upon actuation of a trigger or actuation switch of the setting tool for starting the setting process. The motor operation is preferably only then activated when the setting device has been pressed against the workpiece.

Advantageously, the generator unit has a generator shaft, a drive for rotating the generator shaft and idle means for connecting the generator shaft with a rotor shaft of the electric motor.

Thereby, in a simple way, a connection of the electric motor with the combustion-operated drive takes place only in one rotational direction. This rotational direction corresponds, preferably, to the operational direction of the ventilator, whereby the ventilator is rotated when the electric motor is rotated by the drive to produce the electrical current.

According to an advantageous embodiment of the invention, there is provided pulling rope means that connects the drive with the generator shaft. Thereby, the kinetic energy of the drive which is produced by combustion, is transmitted to the generator shaft. The advantage of pulling rope means consists in that it can be easily guided and deflected in a setting tool. The pulling rope means provides a technically simple connection of the drive with the generator shaft.

Advantageously, the drive has at least one cylinder communicating with the combustion chamber and a piston displaceable in the at least one cylinder and connected with the generator shaft. Thereby, there is provided in addition to a setting piston displaceable in a guide cylinder, a piston also displaceable in a cylinder and having a size that constitute a fraction of the size of the guide cylinder with the setting piston. The cylinder/piston unit permits to easily convert the combustion energy into the kinetic energy that is transmitted to the generator shaft.

Advantageously, the pulling rope means is connected, on one hand, with the piston and, on the other hand, with the generator shaft, which insures, in a simply way, a rotational acceleration of the generator shaft upon pulling of the pulling rope means by the piston. Idle means insures that the rotor shaft can be rotated with the ventilator for some time even after end of the rotational pulse induced by the pulling rope means.

Advantageously, the generator shaft is connected with a spring, whereby the generator shaft can rotate, after the end of the pulling rope means-induced rotation, in an opposite direction, so that the pulling rope means would be wound on the generator shaft by a further amount.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a longitudinal partially cross-sectional view of a setting tool according to the present invention;

FIG. 2 a cross-sectional view along line in FIG. 1;

FIG. 3 a cross-sectional view along line II-II in FIG. 1 during a setting process; and

FIG. 4 a partially cross-sectional view of a section of the setting tool shown in FIG. 1.

### DETAILED DESCRIPTION OF THE PREFERRED EMBODIMENTS

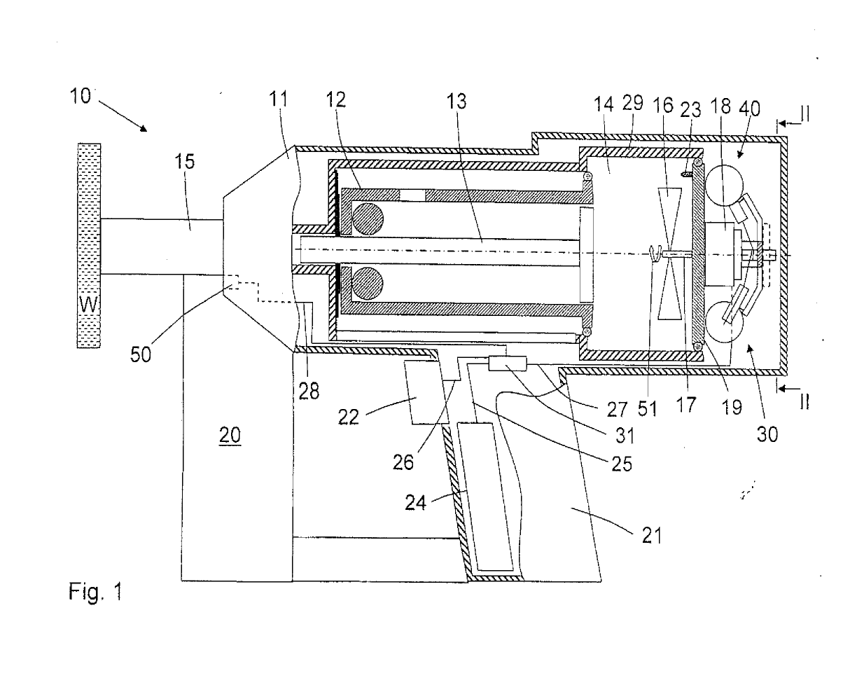

A setting tool 10 according to the present invention, which is shown in FIGS. 1-4, includes a one-or multi-part housing which is generally designated with a reference numeral 11 and in which a setting mechanism is located. With the setting mechanism, a fastening element such as nail, bolt, etc. is driven in a workpiece W when the setting tool 10 is pressed with its bolt guide 15 against the workpiece W and is actuated.

The setting mechanism includes, among others, a combustion chamber 14, a guide cylinder 12 in which a setting piston 13 is arranged for an axial displacement therein, and a bolt guide 15 in which a fastening element can displace. During a setting process, the fastening element is displaced in the bolt guide 15 and is driven in a workpiece W with a forward movable, setting direction-side, end of the setting piston 13 or its piston rod. The bolt guide 15 adjoins the guide cylinder 12 in the setting direction. The fastening elements can be store, e.g., in a magazine 20 securable to the setting tool 10. In FIG. 1, the combustion chamber 14 is already closed, as the setting tool 10 is already pressed against the workpiece W. The combustion chamber 14 is stretched in a combustion chamber sleeve 29 and is limited at its opposite ends by a guide cylinder 12 and the setting piston 13, on one hand, and by a combustion chamber rear wall 19, on the other hand. As further shown in FIG. 1, on a handle 21 of the setting tool 10, there is arranged an actuation switch 22 which actuates an ignition unit 23 secured on the combustion chamber rear wall 19 and formed, e.g., as a spark plug, when the setting tool has been pressed against the workpiece W.

In the embodiment shown in the drawings, the setting tool 10 can be driven with fuel gas or with evaporated liquid fuel that is fed from a fuel container (not shown in the drawings) such as, e.g., a fuel flask, fuel tank, or the like. The combustion chamber 14 is connected with the fuel container by a fuel conduit (likewise not shown in the drawings).

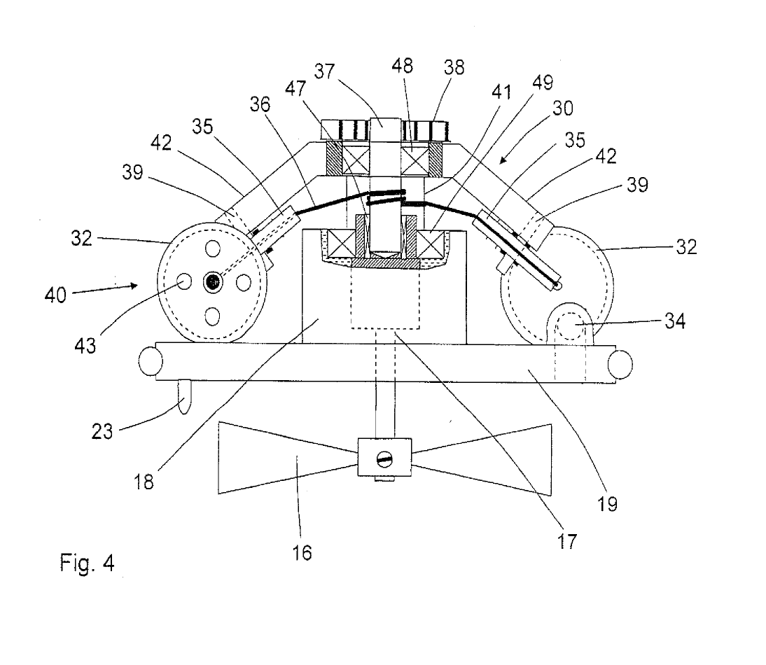

A ventilator 16 (see FIGS. 1 and 4), which is located in the combustion chamber 14, serves for both producing a turbulent flow regime of an oxidant-fuel mixture located in the combustion chamber 14 and for flushing the open combustion chamber 14 with fresh air after execution of a setting process. The ventilator 16 is arranged on an extension of a rotor shaft 17 of an electric-motor 18 which also drives the ventilator 16.

The supply of consumers of electrical energy such as, e.g., the ignition unit 23 and the electric motor 18 with the electrical energy takes place from a network-independent energy source 24 in form at least one accumulator which is charged by a generator unit generally designated with a reference numeral 30. One or more accumulators can be replaceably arranged on the setting tool 10.

The generator unit 30 includes the electric motor 18 that can operate as a generator, and an electronic control unit 31 that switches the electric motor 18 between motor operational state and generator operational state. In the motor operational state, the electronic control unit 31 controls the prime power of the electric motor 18 and in the generator operational state, the electronic control unit 31 controls the generator current of the electric motor 18 that forms the charging current for the energy source 24. The switching from the motor operational state to the generator operational state is effected by a triggering signal upon actuation of the actuation switch of the setting tool 10 for initiating a setting process. The motor operational state is preferably activated only when the setting tool 10 is again pressed against the workpiece W. The control unit 21 is connected with the electrical energy source 24 by a first electrical conductor 25, with the actuation switch 22 by a second electrical conductor 26, and with electrical motor 18 by a third electrical conductor 27. A fourth electrical conductor 28 connects the control unit 31 with a switch 50 that detects application of pressure to the workpiece W by the setting tool 10.

The generator unit 30 also includes a drive for the electric motor 18 and which is generally designated with a reference numeral 40. The drive 40 includes two cylinders 32 which are provided on a side of the combustion chamber rear wall 19 remote from the combustion chamber 14. Channels 34 connect the cylinders 32 with the combustion chamber 14. Pistons 33 are displaceably arranged in the cylinders 32. A pulling rope 36 is connected with each of the pistons 33. The pulling rope 36 passes through respective openings in the cylinders 32 and is guided over respective deflection rollers 35 to a generator shaft 37. As it is particularly shown in FIG. 4, the generator shaft 37 is connected with the rotor shaft 17 of the electric motor 18 by idle means 47 that is supported by a first bearing 48 and a support bracket 41. The idle means-supporting connection section of the rotor shaft 17 is supported, in turn, by a second bearing 49 of the electric motor 18. Both deflection rollers 35 are rotatably supported on support axles 39 which, in turn, are secured on support arm 42 of the support bracket 41.

The pulling rope 36 is wound about the generator shaft 37 several times, whereby a pulsed torque is imparted to the generator shaft 37 when a tensioning load is applied to the pulling rope 36 by one of the two pistons 33. A spring 38, which is formed as a spiral spring is secured to the generator shaft 37, on one hand and to the support bracket 41, on the other hand. Thereby, after the transmission of the rotation to the generator shaft 37 by the pulling rope 36 ends, the generator shaft 37 is rotated by the spring 37 in the opposite direction to somewhat roll up the pulling rope 36 on the generator shaft 37.

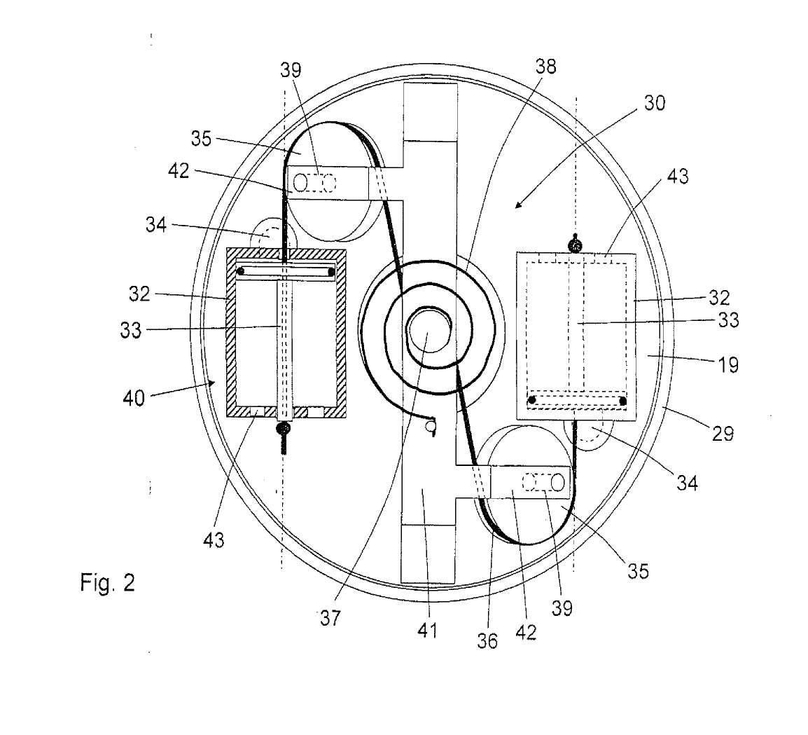

When the setting tool 10 is pressed against the workpiece W, as shown in FIG. 1, the pressure sensing switch 50 becomes closed, turning on the electric motor 18. The ventilator 16 then will be rotated by the electric motor 18 in the direction of arrow 51. At that point in time, the pistons 33 of the drive 40 are located in a position shown in FIG. 2.

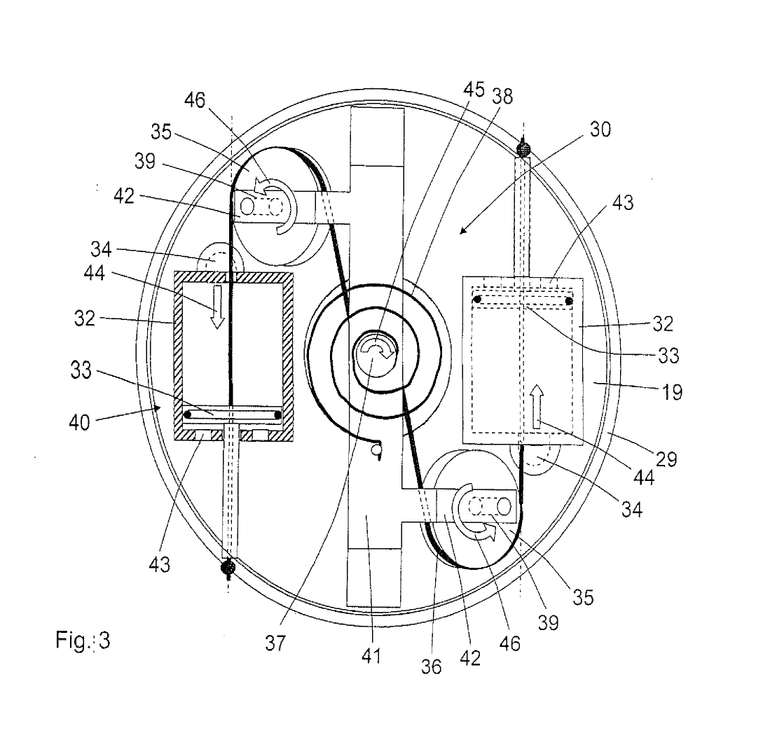

Upon actuation of the actuation switch 22, on one hand, the ignition unit 23 initiates ignition and, on the other hand the control unit 31 cuts off, feed of current to the electric motor 18 (end of the motor operational state of the electric motor 18). However, the inertia of the rotor shaft 17 would continue to rotate the ventilator 16. Simultaneously with the cutting-off of the current supply or, if needed, somewhat later, the control unit 31 switches on the generator operational state of the electric motor 18, i.e., the electricity supply through the electric motor 18. As a result of combustion of the oxidant-fuel mixture or air-fuel mixture located in the combustion chamber 14, both the setting piston 13 and both pistons 33 in the cylinders 32 are driven in the direction of a first arrow 44 because the expanding combustion gases penetrate into the cylinders 32 through channels 34 (see FIG. 3). The air behind the pistons 33 can be vented through the opening 43 in the cylinders 32. The displacement of the pistons 33 will be transmitted, as it has been described above, by the pulling rope 36 to the generator shaft 37, which would rotate in the direction of the second arrow 45. The idle means would transmit the rotation of the generator shaft 37 to the rotor shaft 17 of the electric motor 18 so that the speed of the rotor shaft 17, which meantime has reduced, is increased again. The deflection rollers 37 can rotate on their support axles 39, upon displacement of the pulling rope 36, in the direction of a third arrow 46. The spring 38 is tensioned as a result of rotation of the generator shaft 37, and rotates the generator shaft 37 to its initial position after completion of the combustion process, whereby the pulling rope 36 is somewhat wound on the generator shaft 37. The pistons 33 are displaced in the cylinders 32 again to their initial position shown in FIG. 2.

The electric motor 18 meanwhile produces so much electrical energy during rotation induced by the pulling rope 36 and by subsequent secondary rotation of the rotor shaft 17 that the energy source 24 becomes charged. Further, the ventilator 16, which is rotated by the rotor shaft 17, takes care for a sufficient flushing of the combustion chamber 14 with air.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

1. A combustion-engined setting tool for driving fastening elements in a workpiece, comprising:
a combustion chamber (14) for an oxidant-fuel mixture;
a ventilator (16) located in the combustion chamber;
an electric motor (18) for driving the ventilator (16); and
an electrical energy source (24) for supplying electrical energy to the electric motor (18), the electric motor (18) forming part of a generator unit (30) for generating the electrical energy, wherein the generator unit (30) has a generator shaft (37), a drive for rotating the generator shaft (40), and idle means (47) for connecting the generator shaft (37) with a rotor shaft (17) of the electric motor (18).

2. A combustion-engined setting tool according to claim 1, further comprising pulling rope means (36) for connecting the drive (40) with the generator shaft (37).

3. A combustion-engined setting tool according to claim 2, wherein the drive (40) has at least one cylinder (32) communicating with the combustion chamber (14), and a piston (33) displaceable in the at least one cylinder (32) and connected with the generator shaft (37).

4. A combustion-engined setting tool according to claim 3, wherein the pulling rope means (36) is secured to the piston (33) on one hand and, on the other hand, is wound about the generator shaft (37).

5. A combustion-engined setting tool according to claim 1, further comprising a spring (38) connected with the generator shaft (37).

6. A combustion-engined setting tool for driving fastening elements in a workpiece, comprising:
a combustion chamber (14) for an oxidant-fuel mixture;
a ventilator (16) located in the combustion chamber;
an electric motor (18) for driving the ventilator (16); and
an electrical energy source (24) for supplying electrical energy to the electric motor (18), the electric motor (18) forming part of a generator unit (30) for generating the electrical energy, wherein the generator unit (30) has a control unit (31) for switching the electric motor (18) between a motor operational state and a generator operational state.

7. A combustion-engined setting tool for driving fastening elements in a workpiece, comprising:
a combustion chamber (14) for an oxidant-fuel mixture;
a ventilator (16) located in the combustion chamber;
an electric motor (18) for driving the ventilator (16);
an electrical energy source (24) for supplying electrical energy to electrical consumers of the setting tool including the electric motor (18); and
a generator unit (30) for charging the electrical energy source (24), the electric motor (18) forming part of the generator unit (30).
